(19) United States
(12) Patent Application Publication
(10) Pub. No.: US 2005/0069839 A1
(43) Pub. Date: Mar. 31, 2005

(54) Apparatus for producing or enhancing a perceived sensation of motion

(76) Inventor: Phillip Raymond Denne, Dorset (GB)

Correspondence Address: Douglas J Sprinkle;Gifford Krass Groh Sprinkle Anderson & Citkowski, 280 N Old Woodward Avenue, Suite 400, Birmingham, MI, 48009, US

(21) Appl. No.: 10/312,068

(22) PCT Filed: Jun. 29, 2001
(86) PCT No.: PCT/GB01/02868

(30) Foreign Application Priority Data
Jun. 30, 2000 (GB) 0013059.8

(51) Int. Cl. G09B 9/02

(52) U.S. Cl. 434/29

(57) ABSTRACT

A motion simulator in the form of a seat (11) comprising a seat support frame (12) including a seat back (13), in which a seat pan (19) is movably mounted with respect to the seat support frame (12) via motion actuators (20, 21, 22) which impart to the seat pan (19) motion with respect to the seat support frame (12) with at least three degrees of freedom including sway, and control means (34) for determining the motion of the actuators (20, 21, 22) to move the seat pan (19). Many cues involve moving the seat pan in the opposite sense from the simulated direction of movement.

This invention relates to apparatus for producing or enhancing a perceived sensation of motion as used, for example, in apparatus such as flight simulators which are used in the training of pilots. The apparatus of the present invention can, however, be used for other training purposes, and also for recreational purposes. In use of the apparatus of the invention a seated user is given the subjective impression of movement as a result of simultaneous visual and/or audio stimulation together with motion “cues”. In known such apparatus, the subjective impression of movement is achieved either by pivotal movement of the entire seat or by varying the pressure and/or hardness of an array of pressure pads arranged on the seat and which support the user with varying degrees of support pressure in different parts of the user's anatomy, or a combination of the two.

In the design of such seats, attention has mostly been directed to the motions of pitch, roll and heave (vertical translation), with little attention, if any, being paid to the other possible motions experienced by a body moving in three dimensional space, namely sway (lateral translation), surge (translation along a longitudinal axis) and yaw. Attention has also mostly been directed to motion simulators addressed to gross stimulation of the visceral and haptic-somatic sensory systems to engender the sensation of movement in the user. However the motions to which such apparatus can be subject is limited in the duration of some of the cues that it can generate. This is because a motion base is designed to apply a real acceleration to the occupant that corresponds with the computed acceleration of the virtual vehicle. Real acceleration, of course, results in a real velocity that in turn results in a real movement of the simulator motion base. Since the rams have a finite stroke, the possible displacement of the motion base is strongly limited, which means that the accelerations can only be applied for a short period—fractions of a second. What is more, it is necessary to apply a reverse acceleration immediately afterwards, so as to bring the mechanism to a halt before the rams crash into their end stops. Then the machine has to be returned to its starting position to await the next motion cue demand. The acceleration cues are therefore limited to short-duration “onset cues” and they are followed by reverse motion “wipe-outs”.

One improvement over such known systems is described in U.S. Pat. No. 4,321,044 of G J Kron, which relates to a so-called “G-seat” having a separate seat and backrest, both of which are provided with an array of pressure pads, the internal pressure of which can be varied individually and in accordance with a predetermined program, to vary the degree of support given to different regions of the body of a user seated in the G-seat. The seat pan is pivotally mounted on a motion plate pivotally mounted on the frame and driven by hydraulic rams to provide the pitch motions; the seat pan is also pivoted on the motion plate to achieve an approximation of roll motion and is capable of longitudinal motion along the seat plate, which is traditionally defined as being the direction of fore/aft travel, under the action of a fourth ram. A restraining device determines the pitch and roll axes at fixed locations and any other movement, in particular sway, that is transverse translational motion of the seat pan is specifically prevented by this stabiliser. A similar three point drive is provided to the backrest to provide pitch, roll and surge motions, but in this case with both lateral and vertical stabilisers to prevent both sway and heave, that is lateral movement of the backrest or translation of the backrest in a vertical direction.

An important element creating a perception of motion in a motion simulator is the scrubbing effect simulating relative movement of the occupant in relation to the seat. The importance of such cueing motions is recognised in U.S. Pat. No. 4,030,207 in. which provision is made for linear displacement of the seat cushion surface along either of the two orthogonal axes, such displacement taking place in the plane of the cushion surface by physically displacing the surface covering of the seat with respect to the seat itself whereby to generate what may be referred to as skin tension/contraction cues in the user.

The present invention is directed to apparatus for producing or enhancing a perceived sensation of motion in which the motion to be sensed by the user is represented by clues or cues which are produced without gross movement of the seat itself but rather by subtle relative movements of some part or parts of the seat with respect to another or others, in particular by movements of the seat pan upon which the user is seated, relative to the frame of the seat which is fixed. The actual movement of the seat is not necessarily in a direction intuitively associated with the sensation of movement intended to be perceived by the user. As will be described in more detail below the seat pan may be simultaneously subjected to one or more motions selected from up to five of the “natural” degrees of freedom namely pitch, roll, sway, surge and heave. Although the user may be caused to perceive yaw motion this is not created by displacements about the yaw axis but rather by combinations of other displacements. The motion to be perceived by the user in the context of this invention may also be selected from any combination of surge, sway, yaw, pitch, roll and heave by means of cues given from very small relative movements of he seat as will be described in more detail below.

According to one aspect of the invention apparatus for producing or enhancing a perceived sensation of motion in the form of a seat comprising a seat support frame including a seat back, is characterised in that a seat pan is movably mounted with respect to the seat support frame via motion actuators which impart to the seat pan motion with respect to the seat support frame with at least three degrees of freedom, and control means for determining the motion of the actuators to move the seat pan with respect to the frame to provide the simulated motion.

The perception or enhanced perception of motion is achieved by moving just the seat pan in such a way as to vary the skin pressure between the user and those parts of the seat contacted thereby.

As used in this specification the term “seat pan” will be understood to refer to the platform or squab on which a seated person actually sits regardless of whether this is padded or unpadded. Likewise, when referring to the “general plane” of the seat pan it will be understood that this refers to a plane in which the majority although not necessarily the entirety of the seat pan lies.

Also in accordance with this invention there is provided an apparatus for producing or enhancing a perceived sensation of motion comprising a support platform having five or six degrees of freedom, that is to say rotational freedom about each of two or three orthogonal axes, and translational freedom along each of these axes.

When a person is seated in a moving vehicle (car, boat, plane etc,) the occupant of the seat always moves within the seat in the opposite direction from that of the motion of the seat itself. This is because, if the vehicle changes course in any dimension, the inertia of the occupant acts to make him/her continue on the original course—and as a result the occupant is pressed against the opposite seat surface. It is therefore possible to design a completely new form of motion cueing system in which the seat occupant is moved by the seat pan a fraction of an inch in the opposite direction to that of the virtual vehicle motion. So the occupant is pressed against the appropriate surface of the seat, as would be the case in reality. Of course, there are limitations to the technique in the case of heave accelerations, but that is common to all other forms of motion cueing system.

In another aspect, the present invention provides apparatus comprising a support platform constituting or mounting a seat pan, the said platform being freely movable, over a limited range of motion with at least five degrees of freedom with respect to a seat frame. The seat frame may be static or may be itself mounted on a motion base to provide gross positional changes as well as the motion cues from the motion of the seat pan which effectively “floats” in relation to the seat frame.

Motion simulation is achieved, in accordance with the present invention, without the need for pressure pads located on the seat pan or on the backrest, and without varying the hardness of the support surface, and/or without varying the tension in a lap belt fitted to secure the user in the seat, although any or all of these may be added to reinforce the simulation if considered appropriate to particular circumstances.

Embodiments of the invention may be so formed that, in order to permit horizontal movement of the seat pan, that is movement within the plane of the pan when lying at rest, no separate dead load carrying means or lateral restraining means are required. In such embodiments the actuators provide the sole support for the motion plate on which the seat pan is carried as well as providing the pitch, roll, sway, surge and heave motions (and yaw if provided). For this purpose the actuators may be combined electromagnetic linear actuators with fluid pressure support or backup. Suitable such actuators are described in, for example WO98/37615. Preferably the sole support for the motion platform is provided by the actuators. These actuators are connected to the motion plate at the three corners of a triangle, preferably an equilateral triangle. In one embodiment they may be substantially vertically oriented between the support plate and the motion plate, although in order to permit the extra degrees of freedom to the motion plate for surge and sway motion universal linkages or joints are needed at each end of each actuator, and further actuators for providing these motions may be provided. Alternatively, the actuators may be inclined to one another in a configuration resembling a truncated tetrahedron. As a further alternative, six actuators in a so-called “Stewart platform” configuration may be provided to give up to six degrees of freedom. The configuration of the actuators used to support and drive the motion plate relative to the fixed support frame may be such as to provide an axis of rotation parallel to and adjacent the leading edge of the seat pan for a single actuator; for example the front of the motion plate may be supported by two actuators equi-spaced on opposite sides of the longitudinal axis whilst the rear (front and rear in this context, and elsewhere in the present description, being relative to the direction in which the user faces when seated in the simulator) is supported by a single actuator.

In one embodiment of the present invention, the motion plate to which the seat pan is mounted, or which itself constitutes the seat pan, or a section thereof, may be provided with up to three of its degrees of freedom namely surge, sway and yaw by means of actuators operating in the general plane of the motion plate. The three actuators may comprise three further preferably electromagnetic rams each operating along a respective line of action. Alternatively six actuators, preferably electromagnetic rams located in pairs to work in opposite direction along each of these three lines of action may be provided. These rams, (three or six as the case may be) operate co-operatively to drive the motion plate linearly (or in rotation for yaw), and in the plane of the plate, either along the longitudinal or transverse directions, or both simultaneously. Movement of the seat pan along the longitudinal direction serves to cue the perceived motions in the user of surge (forward movement or acceleration) or negative surge (braking), the perceived motion being opposite the actual motion of the seat pan, that is forward movement of the seat pan along the longitudinal direction is perceived by the user as negative surge, that is rearward movement or braking, whilst movement of the seat pan transversely of the longitudinal direction serves to cue motions perceived by the user as sway, the perceived or apparent direction of movement likewise being opposite that of the actual movement of the seat pan transverse the longitudinal direction.

A particular advantage of the arrangement of this invention, besides adding surge and sway capability to the motion simulator, is that it can be used to provide strong and accurate simulation of a vibrational environment. In general this has not been possible or practical in the past. Vibrational motion is possible largely due to the use of electromagnetic actuators as these have a wide bandwidth of mechanical response to the stimulating signals.

In the embodiments described above, the position of the seat pan on the motion plate is preferably such that the centre of mass of the user, that is the person seated on the seat pan, is at least substantially directly above the centroid of the triangle of the connection points of the actuators with the motion platform.

It is possible, within the principles of the present invention, to provide the motion platform with a further degree of freedom (for which a further drive mechanism may be provided (unless a six actuator Stewart platform configuration is used), this being that of rotation about an axis perpendicular to the plane of the motion plate. This final degree of freedom rotates the motion plate to a limited extent about a substantially vertical axis thereby to cue a perceived sensation of yaw in the user. As mentioned above the yaw sensation can be cued by means of a combination of pitch and roll movements with a possible contribution from sway. The use of the true yaw motion of the seat pan may also contribute to this but can be used to reinforce other cues as well. All six of the motions capable of being experienced by a body moving in three-dimensional space, that is any or all of pitch, roll, heave, surge, sway and yaw can all be simulated with the apparatus of the invention.

Various opportunities exist for the location of the yaw axis. Generally, the yaw axis will be aligned on the longitudinal axis, and within the equilateral triangle formed by the connection of the actuators on which the motion plate is carried, although there may be occasions when the yaw axis is set to one side or the other of the X axis itself for special purposes. Likewise the yaw axis will generally be set either at the point of intersection of the longitudinal and transverse axes or so as to pass substantially directly through the centre of mass of a user seated on the seat pan, although, as mentioned, the two are preferably coincident. Other possibilities exist, however, such as positioning the yaw axis in front of or behind the centre of mass of the user. This has application where the apparatus is used for special purposes such as for an entertainment simulator rather than for a training simulator.

Generally the apparatus of the present invention will have a seat back or backrest as well as a seat pan. As is the normal practice both will usually be upholstered for the comfort of the user. Either or both may additionally be provided with pressure pads and/or hardness modulators, although a primary objective of the invention is to provide a motion simulator which is effective without them. Where present, such pressure pads and/or hardness modulators may be of any known design.

In the motion simulator of the present invention the seat pan is entirely independent of the seat back or backrest and there is no need for motion of the seat back or backrest with respect to a stationary frame of reference in order to achieve the motions simulation.

Generally the apparatus of the invention will comprises an adjustable seat belt for the user. As mentioned above, a separate drive for tensioning and releasing the seat belt is not needed in order to give the motion cues, but of course the seat belt may be positively driven in association with movements of the seat if required. One of the advantages of the present invention over the prior art is that, in the present invention, such tensioning variation is not necessary, the seat belt need not be tensioned other than by adjustment for fitting.

Where reference is made in this specification and claims to the perception of motion by the user, such term is to be taken as including enhancement of that perception, that is the perception itself may be initiated or cued by other means, the present invention serving to enhance the already initiated perception.

Embodiments of the present invention will now be more particularly described, by way of example, with reference to the accompanying drawings, in which:

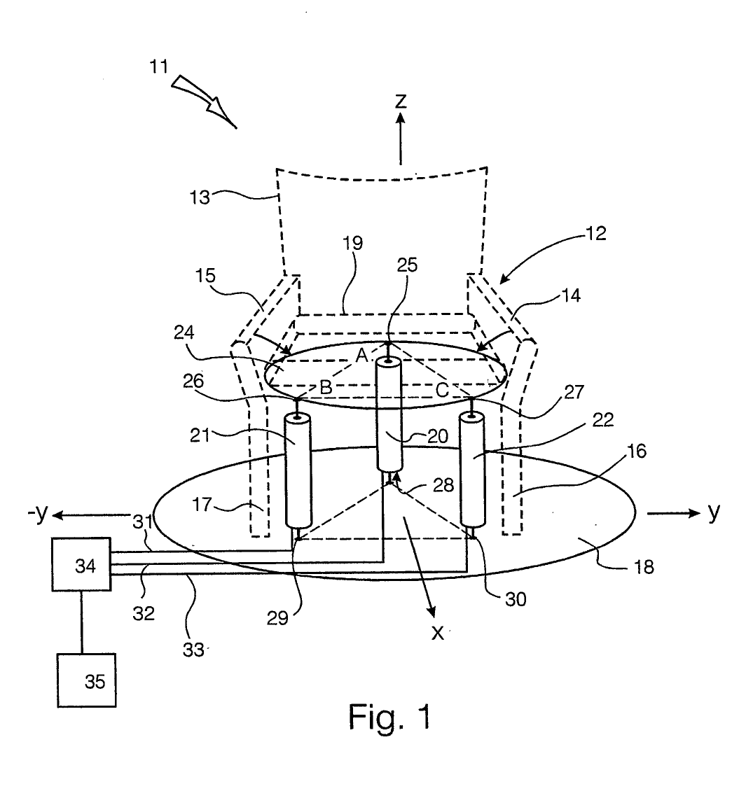

FIG. 1 is a schematic diagram illustrating a simulator seat formed as one embodiment of the present invention;

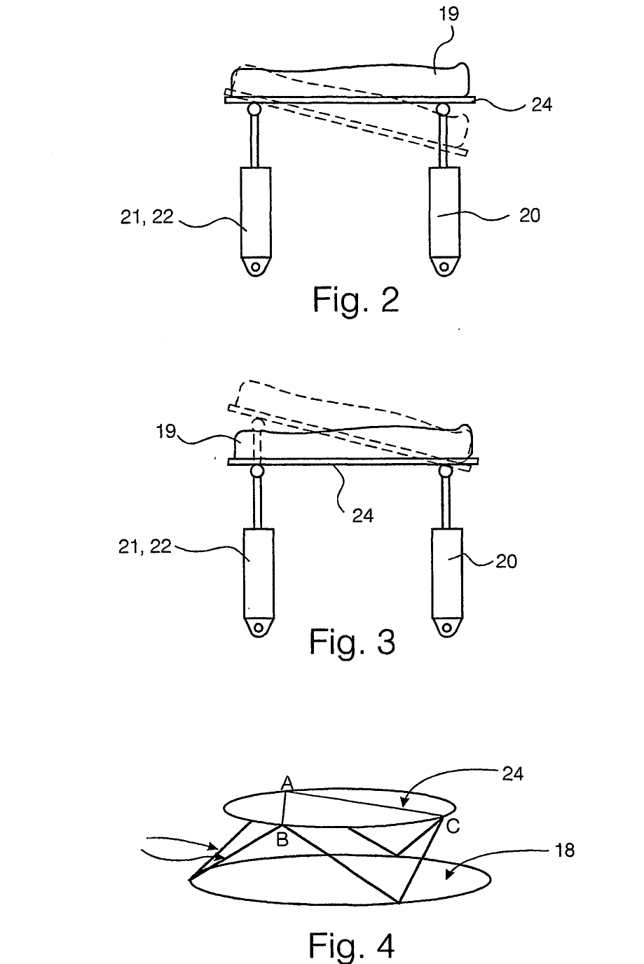

FIG. 2 is a schematic side view of the embodiment of FIG. 1 in a first operating configuration;

FIG. 3 is a corresponding schematic side view of the embodiment of FIG. 1 showing the device in an alternative configuration;

FIG. 4 is a schematic diagram illustrating an alternative embodiment of the invention;

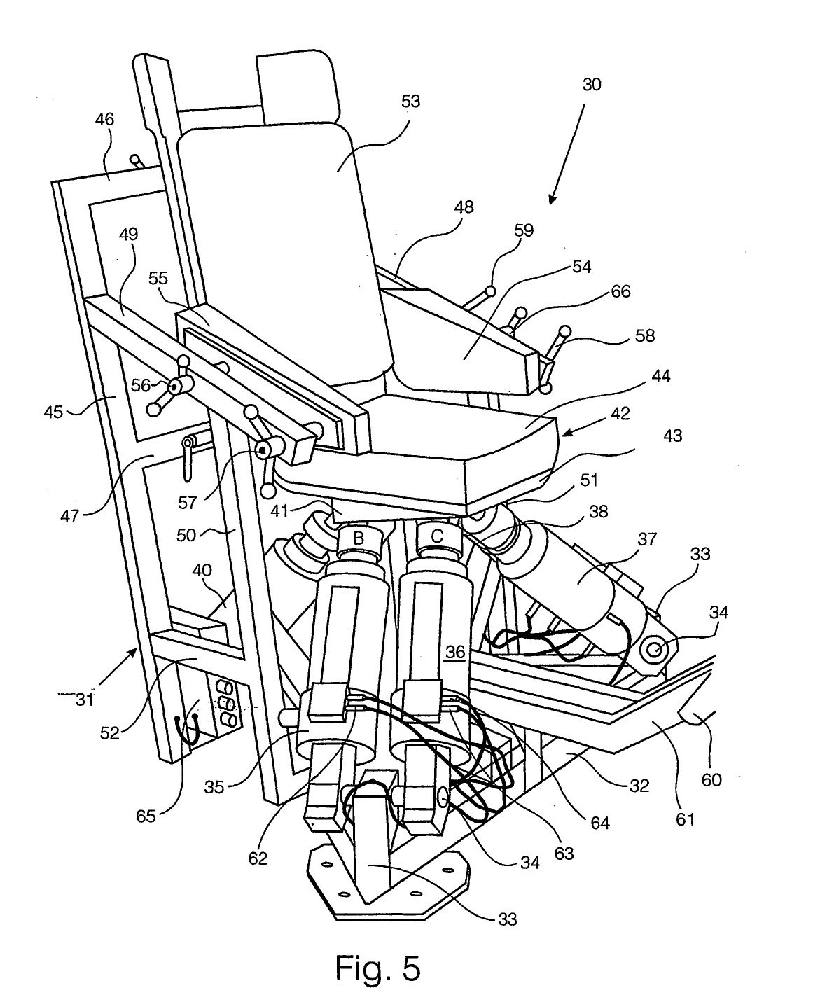

FIG. 5 is a perspective view of a further alternative embodiment of the invention; and

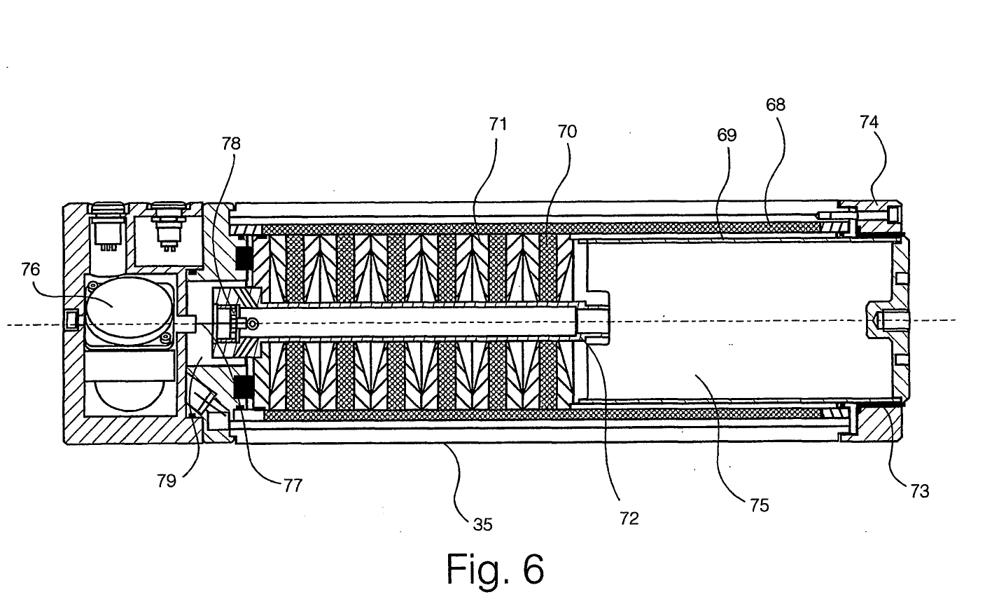

FIG. 6 is an axial sectional view of an electromagnetic ram suitable for use in embodiments of the invention.

Referring now to the drawings, FIG. 1 illustrates a simulator seat generally indicated 11 comprising a fixed frame 12 having a seat back 13, left and right arm frames 14, 15, legs 16, 17 mounted on a fixed platform 18. All these components are securely and rigidly fixed together so that no relative movement between any of them can take place.

Between and beneath the arms 14, 15 is located a seat squab or seat pan 19, being that component on which an occupant is seated when occupying the simulator seat. The seat pan 19 takes the entire weight of the seated occupant. The seat pan 19 is carried by three linear actuators 20, 21, 22 which are preferably of electromagnetic type as described in the inventor's earlier PCT application WO98/37615. The linear actuator described in this earlier document produces a controlled axially-directed force and comprises two main relatively movable members adapted to slide telescopically one within the other, a plurality of annular coils are fixed to at least a portion of the axial length of one of the relatively movable members, and means for generating circumferential electric currents in the annular coils. The other relatively movable member has means for producing a plurality of magnetic fluxes the polarity of which alternates along at least a portion thereof. The current generating means act to vary either one or more of the frequency, the phase or the amplitude of the electric currents in the coils so as to cause the electric currents and magnetic fluxes to interact and to provide a force tending to cause relative motion between the members which each have an open end and a closed end and are fitted one within the other to define an enclosed volume between them. This enclosed volume is filled with a fluid under pressure, preferably gas, which enables the actuator to support a static load without energisation of the coils.

In the context of this application, therefore, each of the actuators 20, 21, 22 contributes to supporting the load of a user on the seat pan 19 which rests on a movable platform 24 to which the actuators 20, 21, 22 are pivotally connected by universal joints 25, 26, 27 respectively. At their lower ends the actuators 20, 21, 22 are connected to the support platform again by respective universal joints 28, 29, 30. The movable platform 24, and thus the seat pan 19, is carried solely by the actuators 20, 21, 22 and is therefore free to “float” in relation to tie fixed frame 12. For this purpose the platform 24 is made two dimensions slightly smaller than the available space within the frame 12 so that it is free to move, albeit over a limited range, horizontally within its own plane as well vertically. Tilting motions about either a longitudinal or a transverse axis may also be made as will be described in more detail hereinafter below. In this context the longitudinal axis, represented by the arrow X in FIG. 1, coincides with the four and aft axis of the seat 11, with positive displacement in the X direction being represented by forward movement or movement in the direction in which the occupant faces. The transverse axis, represented by the line Y-Y in FIG. 1, lies orthogonally to the longitudinal axis and in the same horizontal plane. The third axis, namely the Z axis represents the vertical direction as illustrated by the arrow Z in FIG. 1, and is orthogonal to the plane defined by the XY axis in the usual cartesian convention.

Control signals to the actuators 20, 21, 22 are applied via lines 31, 32, 33 from a control unit 34 which itself receives signals from a demand unit 35 which may be a manual control unit for real-time control of the seat, or may be a recorded program relating to, for example, the images displayed to the user on a screen (not shown) facing the seat 11 or a virtual-reality headset (again not shown) which the user may wear.

The art of simulating motion has been developed over a number of years as described in the preamble to this specification: one of the continuing problems, however, is that of the limited range of the actuators which provide the motion simulation. In early simulators where the motion is actually reproduced, rather than simulated, acceleration upward, for example, is represented by raising the entire seat structure, rolling to the left and right is simulated by corresponding such motions. However, such so-called “gross movement” simulators could not provide a representation of sustained acceleration in one direction since the actuators would reach the end of their travel long before the desired simulation came to an end. For this purpose the so-called g-seat was developed, which provides motion queues rather than gross motion which, in combination with the images represented to the occupant of the seat, provided a psychological rather than a real representation of the motion. Increasingly complex and sophisticated systems have been developed in order to convince the occupant that the simulated motion is in fact taking place, including means for moving the seat pan and the seat back in relation to one another, skin “scrubbing” arrangements for moving the surface of the seat pan and and/or the seat back in the plane of contact with the user to simulate the “tug” experienced by the user in a real-life situation when his or her body weight is caused to shift in relation to the seat itself, and various inflatable pressure pads for varying the pressure experienced by different parts of the seat occupant's anatomy again to simulate the hardness variations which are experienced in different attitudes and with different acceleration patterns.

The present invention is based on the realisation that such psychological motion cues are not all necessary in order to provide a realistic representation of the motion, and that by simply displacing the occupant in relation to the seat frame by moving him or her by means of motion of the seat pan a very credible simulation of motion, especially sustained acceleration, can be achieved without the need for such complex structures as have been developed. For this purpose the seat pan can be made to be capable of movement over a greater range in relation to the frame than in conventional g-seats, although not over such a great range as in gross motion simulators, and the “scrubbing” action between the occupant and the parts of the seat with which he or she comes into contact can be achieved by effecting real scrubbing motions of the occupant against the static parts of the seat by moving the occupant rather than the seat. It is anticipated, however, that in order to apply the required skin pressure variations to simulate sustained acceleration only very small movements will be actually required for the majority of circumstances.

Thus, for example, if it is desired to simulate vertical acceleration in the Z direction this is achieved by shortening each of the actuators 20, 21, 22 by the same amount to cause the seat pan 19 to descend with respect to the seat frame 12 thereby giving the occupant the impression that the seat frame is rising with respect to a frame of reference centred on the occupant himself, which is the same physical sensation as that occurring during real vertical acceleration as the inertia of the occupant causes him or her to be pressed down into the seat and thus occupy a lower position than in steady state conditions. Of course, it is appreciated, that this simulation does not provide the visceral stimulation of acceleration, but in combination with the visual images presented at the same time can act to provide a credible simulation. In the same way a sustained acceleration to the right, for example simulating a long sweeping curve to the right of a motor vehicle, can be simulated simply by rolling the seat pan to the left causing the occupant to experience greater pressure on the left side from the left hand seat arm 14, and also experience a slight lateral tug or scrub on the back again simulating the inertia of the occupant in a real situation.

In general, as explained above, all simulated motions are represented by actual displacement of the seat pan in the opposite direction of that of the motion being simulated, that is the opposite direction from that which the seat as a whole would move in a real displacement corresponding to that simulated. Positive heave, as mentioned above, is simulated by lowering the seat pan 19 in the negative Z direction and negative heave, that is deceleration vertically (or downward acceleration) is represented by elevating the seat pan 19 by extending the actuators 20, 21, 22 in relation to the seat frame 12.

The articulation of the ends of the actuators 20, 21, 22 to the fixed platform 18 and to the movable platform 24 on which the seat pan 19 is supported allows a limited translational movement of the seat pan 19 to take place, this being effected by further actuators (not shown) acting between the frame 12 and the platform 24 in a horizontal direction, typically parallel to the X and Y axes.

One advantage of mounting the seat pan 19 on a platform 24 which is supported independently of the frame 12, in a manner which can be characterised as a “floating” mount, lies in the fact that the axis about which any rotation takes place can be shifted within the area of the platform 24, or, indeed, to lie outside the area of the platform 24 by suitably controlling the actuators 20, 21, 22. One example of this is illustrated in FIG. 2 and FIG. 3 in which the seat pan 19, the platform 24, the left hand front actuator 22 and the rear actuator 20 are shown. It will be appreciated that the preferred configuration of the actuators 20, 21, 22 is as shown in FIG. 1 with a lower ends of the actuators 20, 21, 22 connected to the fixed platform 18 by articulation couplings 28, 29, 30 located at the corners of an equilateral triangle which is the same size as the equilateral triangle made by the articulated couplings 25, 26, 27 by which the upper ends of the actuators 20, 21, 22 are connected to the platform 24, with the actuators 21, 22 defining the transverse plane at the front of the platform 24 and the actuator 20 controlling the rear of the platform 24. If, in simulating a particular motion, it is desired to tilt the platform 24 and thus the seat pan 19 rearwardly, this can be achieved as illustrated in FIG. 2, by turning the seat pan 19 about an axis passing through the two articulations 26, 27 by maintaining the actuators 21, 22 at an unchanged length and shortening the actuator 20. Lengthening the actuator 20 would cause the seat pan 19 to tilt forwardly about an axis passing through the two articulations 26, 27. However, in other circumstances rearward tilting of the seat pan may more preferably be achieved by maintaining the length of the rear actuator 20 and extending the front actuators 21, 22, in which case the seat would tilt about a transverse axis passing through the articulation 25.

As indicated above, if it were desirable to turn the seat pan 19 about an axis outside its own area this could be achieved by extending the actuators 21 and 22 by an amount greater than the actuator 20 such that the tilt took place about an axis somewhere to the rear of the seat. This allows a wide variety of simulated motions to take place. For example, when simulating vertical acceleration it may be more appropriate simply to lower the rear of the seat 20 as illustrated in FIG. 2 since the majority of the occupant's weight is communicated to the seat via the ischial tuberosities in line with the hip joints. Relatively little of the occupant's inertia affects the front of the seat However, when simulated acceleration or deceleration in a four-and-aft direction it may be more appropriate to raise or lower the front of the seat leaving the rear of the seat at a fixed height in order to avoid raising or lowering the occupant's line of sight and thereby increasing the perception intended by the simulation.

FIG. 4 illustrates an alternative configuration in which the platform 24 is mounted on six actuators mounted in pairs connected to the same articulation points 25, 26, 27 as the individual actuators 20, 21, 22 of the embodiment of FIG. 1, the actuators being identified as left and right components 20L, 20R, 21L, 21R, 22L, 22R. This known platform configuration enables the platform 24 to move with six degrees of freedom without requiring any additional actuators, and in particular can cause horizontal translations in the XY plane, rotation about the Z axis (yaw) as well as the heave, pitch and roll displacements discussed above in relation to the embodiment of FIG. 1.

It is also possible to combine the present invention with a gross motion simulator by mounting the fixed platform 18 on a motion base (which itself may be a stewart platform) having long-reach actuators such that the seat frame 12 itself can be caused to perform physical displacements or rotations within a limited range. Such a structure would provide the advantage of being able to stimulate both the visceral and haptic systems simultaneously to achieve a more realistic simulation of motion, especially sustained acceleration.

An advantage of utilising electromagnetic actuators 20, 21, 22 lies in the frequency response of such devices, which are capable of applying to the seat pan 19, and thus to the seat's occupant a vibratory motion up to several tens of Hz which is achieved only with difficulty utilising hydraulic actuators.

The algorithm driving the actuators is preferably formulated so that not only is the motion to be perceived by a user seated on the seat pan cued by a brief cueing movement of the seat pan in the opposite direction, so that the sensation resulting from the tugging or dragging or scrubbing which occurs between the user or his clothes and the fixed parts of the seat as the seat pan (and therefore the user) is displaced, results in a change in skin tension or contraction brought about by the scrubbing action and thus a perception of motion. The algorithms used to drive the actuators should preferably be formulated so as to provide rapid washout at the end of each movement, especially lateral motion: longitudinal motion may have a longer washout. This is needed in order to ensure availability of motion in the same or opposite direction immediately after any given motion.

The configuration of the seat is such that the centre of mass of a person seated on the seat pan, and which for practical purposes can be equated with the position of the navel, is directly above the centroid of motion of the seat pan 19. This may or may not coincide with the Z-axis.

Referring now to the embodiment of FIG. 5, a motion simulator generally indicated 30 has a fixed seat frame 31. The seat frame 31 comprises a base 32 of generally triangular configuration at the apices of which are three upstanding bosses 33 through which pass respective pivot pins carrying resilient bushes 34 on which are mounted respective pairs of linear actuators 35, 36; 37, 38 and 39, 40. In fact the actuator 39 is not visible in FIG. 5 as it is masked by the actuator 40. Each of the actuators 35, 36; 37, 38; 39, 40 is connected at its lower end to the resilient bushes 34 on the support bosses 33, and pivotally connected at its upper end to a seat support plate 41 of triangular shape on which is mounted a seat pan generally indicated 42 comprising a rigid seat plate 43 and a relatively firm cushion element 44. The resilient bushes, although cylindrical in shape, out in practice as universal joints of limited displacement, and are silent in operation.

The configuration of the linear actuators 35-40 is, in practical terms, comparable to the “Stewart” platform configuration of FIG. 4, but in which the triangle of connection points ABC in FIG. 5 is rather smaller than that illustrated in FIG. 4 so that, with the actuators themselves being of greater transverse thickness and mounted in pairs on the bushes 34, each adjacent “V” of the actuators in FIG. 4 is constituted by a pair of approximately parallel actuators as shown in FIG. 5. The actuators 35, 36, for example, have been marked with the letters B and C to indicate the corresponding connection points B and C of actuators in FIG. 4. As will appreciated, the seat pan 42 is carried on the seat support plate 41 solely by the six actuators 35-40, in turn supported solely on the base 32.

Upwardly from the base 32 extends a rigid support frame generally indicated 31 comprising a rear rectangular frame of upright columns 45 reinforced by two transverse struts 46, 47. Forwardly from the columns 45 project two inclined supports 48, 49 in turn supported by upright columns 50, 51 adjacent their forward ends, the columns 50, 51 being in turn secured to the upright rear frame by rails 52.

A backrest 53 is fixedly supported on the fixed frame 31, by means not shown, and thigh supports 54, 55 are carried by the inclined arms 48, 49, and are adjustable by means of screw threaded adjusters 56, 57, 58, 59. It will be appreciated that the thigh supports, 54, 55 and the backrest 53 are all rigid, non-moving parts held stationary by the support frame 31 on the base 32 whilst the seat pan 42 is movable, in the manner described herein above, with respect to these fixed components in order to provide a simulation of motion.

A footrest 60 carried on a projecting arm 61 is likewise secured to the base 32 and fixed in relation thereto. Electrical leads 62, 63, 64 lead from a control panel 65 to the individual actuators 35-40 so that these can be caused to extend or contract individually in accordance with the desired motion.

For use as a training simulator, the controls of the actuators are linked to a control column 66 by which the user applies demand signals to the control unit 65 in accordance with external stimuli, such as an image projected on a screen in front of the simulator.

The motion simulation can represent sustained accelerations as well as specific movements, and the use of electromagnetic actuators allows high frequency motion, particularly vibrations, to be applied to the seat pan 42 thereby providing a more realistic simulation of the real experience.

One of the more difficult motions to provide a credible simulation is that of “heave” that is vertical acceleration or deceleration in view of the limited range of motion of the simulator components in comparison with those available to a real vehicle such as an aircraft. This means that sustained acceleration must be represented to the user in a way which allows his or her brain to interpret the cue as representative of this fact without it being possible, naturally, to apply real acceleration. It has been found that a heave simulation of upward acceleration is more credible if it starts by applying an increased vertical pressure to the user by elevating the seat pan slightly in relation to the thigh supports 54, 55 and back 53, and follow this by a slow descent. This gives the user first the sensation of increased pressure and then the sensation of sinking into the seat in relation to the back and thigh supports which is reminiscent of the corresponding physical effect in a real aircraft where the operator is pressed down into the seat by sustained vertical acceleration.

Likewise, apparent yaw motions can be simulated by a combination of pitch, roll and lateral translation (sway) applied in a specific sequence which causes the user to develop an apparent sensation of yawing.

FIG. 6 illustrates the structure of an electromagnetic ram suitable for use in the embodiment of FIG. 5. The ram, illustrated as the ram 35, has an outer casing 67 within which are formed and secured thereto a plurality of annular coils 68.

A tubular “piston rod” 69 is attached to an array of annular magnets 70 interspaced by tapered pole pieces 71 and carried on a central tubular carrier 72.

A seal 73 between the cylindrical outer surface of the tubular “piston rod” 69 and an annular end cap 74 ensures that the interior chamber 75 of the actuator is sealed from the outside.

The opposite end the actuator contains a position encoder 76 connected by an extensible line 77 to the movable magnet array, by a coupling having passages 78 which allow communication from the interior of the tubular member 72 to the chamber 79 within the actuator on the opposite side from the magnet array 71 from the chamber 75. The interior of the actuator, comprising the chamber 75, the interior of the tubular member 72 and the chamber 79 contains a gas under pressure so that the actuator is capable of supporting a load without necessity for the coils 68 to be energised to displace the magnet array 71. Such actuators are capable of rapid movement, are silent in operation, and suffer no leakage of oil like hydraulic actuators. They are capable of very rapid displacements so as to be able to apply not only motion cueing displacements, but also vibration to the movable seat pan and shock loading to simulate motions which cannot be represented bysimulators using less responsive actuators.

1. Apparatus for producing or enhancing a perceived sensation of motion in the form of a seat comprising a seat support frame including a seat back, characterised in that a seat pan is movable with respect to the seat support frame via motion actuators which impart to the seat pan motion with respect to the seat support frame with at least three degrees of freedom and control means for determining the motion of the actuators to move the seat pan with respect to the frame to provide the simulated motion.

2. Apparatus for producing or enhancing a perceived sensation of motion according to claim 1, characterised in that, the motion actuators are electromagnetic actuators, preferably electromagnetic linear actuators.

3. Apparatus for producing or enhancing a perceived sensation of motion according to claim 2, characterised in that the seat pan is supported by actuators connected between the seat pan and the seat support frame.

4. Apparatus for producing or enhancing a perceived sensation fo motion as claimed in claim 3, characterised in that the actuators provide the sole support for the seat pan.

5. Apparatus for producing or enhancing a perceived sensation of motion according to claim 3, characterised in that the motion actuators between the seat support frame and the seat pan are linear actuators in an arrangement which allows translational movement of the seat pan in the general plane thereof with respect to the seat support frame.

6. A motion simulator according to claim 5 characterised in that there are six linear motion actuators between the seat support frame and the seat in a configuration in which the actuators are located in pairs each pair acting at a respective corner of the said triangle.

7. Apparatus for producing or enhancing a perceived sensation of motion according to claims 5 to 6 characterised in that translational movement of the seat pan with respect to the seat support frame is provided by actuators acting between the seat pan and the seat support frame in the general plane of the seat pan.

8. Apparatus for producing or enhancing a perceived sensation of motion according to any of claims 3 to 6, characterised in that the actuators are connected to the eat pan at the corners of a triangle and the seat pan is positioned with its front edge parallel to one of the sides of the said triangle.

9. Apparatus for producing or enhancing a perceived sensation of motion according to claim 8, characterised in that the said triangle is a substantially equilateral triangle.

10. Apparatus for producing or enhancing a perceived sensation of motion according to claim 8 or claim 9, characterised in that the position of the seat pan on the support frame is such that the centre of mass of a user seated on the seat pan is substantially directly above the centroid of the triangle.

11. Apparatus for producing or enhancing a perceived sensation of motion according to any preceding claims, characterised in that the motion actuators between the seat pan and the seat support frame are arranged to provide translational movement of the seat pan with respect to the seat frame in two directions orthogonal to one another.

12. Apparatus for producing or enhancing a perceived sensation of motion according to claim 10, characterised in that the said two orthogonal directions are lateral and longitudinal.

13. Apparatus for producing or enhancing a perceived sensation of motion according to any preceding claim, characterised in that it further includes a seat belt for a user when seated in the simulator, the seat belt being adjustable in length to adapt to the user of the simulator and variable in tension during operation of the simulator.

14. Apparatus for producing a enhancing a perceived sensation of motion according to any preceding claim, characterised in that there are provided or also provided means for supporting the static load on the seat pan separately from the said actuators.

15. A method of producing or enhancing a perceived sensation of motion using a simulator as claimed in any preceding claim, characterised in that the sensation of motion perceived by the user is achieved or enhanced by cueing signals produced by movement of the seat pan with respect to the seat frame as permitted by one or more of its degrees of freedom and effected by operation of respective motion actuators, the direction and duration of movement of the seat pan being such as to simulate the motion to be perceived by the user.

16. A method of producing or enhancing a perceived sensation of movement according to claim 15, characterised in that it comprises causing limited, brief movement of the seat pan upon which the user is seated, relative to a fixed support, along or about a given axis, the actual movement of the seat being in a direction opposite to the sensation of movement intended to be perceived by the user.

17. A method of producing or enhancing a perceived sensation of motion according claim 16 or claim 16, characterised in that, the displacement of the seat pan with respect to the seat frame takes place first in one directional sense and they in another directional sense during the same simulated movement.

18. A method of producing or enhancing a perceived sensation of motion according to claim 17, characterised in that, the simulated perceived sensation is heave and the seat pan is first raised and then lowered with respect to the seat frame during the simulated motion.

19. A method of producing or enhancing a perceived sensation of motion according to any of claims 15 to 18, wherein the motion(s) to be perceived by the user comprise translational (surge or sway) motions along or transverse to the direction in which the user seated on the seat pan faces, and wherein the perceived surge, including negative surge, motion is cued in the user by movement of the seat pan along that axis and in the opposite direction from that which is to be perceived by the user, and the perceived sway motion is cued in the user by movement of the seat pan in a direction transverse to that axis and in the opposite direction to the direction of the sway motion that is to be perceived by the user.

20. A method of producing or enhancing a perceived sensation of motion according to claim 19, characterised in that, the translational motion is accompanied simultaneously with pitch and/or roll motion.

21. A method of producing or enhancing a perceived sensation of motion according to any one of claims 16 to 20, wherein the seat pan is simultaneously subjected to any two or more other motions selected from pitch, roll, heave, surge and sway.
